(19) United States
(12) Patent Application Publication
(10) Pub. No.: US 2011/0172798 A1
(43) Pub. Date: Jul. 14, 2011

(54) Structured Porosity or Controlled Porous Architecture Metal Components and Methods of Production

(76) Inventors: Mark Staiger, Christchurch (NZ); Timothy Bryan Francis Woodfield, Christchurch (NZ)

(21) Appl. No.: 13/062,352

(22) PCT Filed: Aug. 24, 2009
(86) PCT No.: PCT/NZ09/00174

§ 371 Date: Mar. 4, 2011

(30) Foreign Application Priority Data
Sep. 4, 2008 (NZ) 571059

(51) Int. Cl. G06F 19/00; G06F 17/50

(52) U.S. Cl. 700/98; 703/1

(57) ABSTRACT

A method of forming a product such as a biomedical implant of Mg or Al includes computationally designing the product including a controlled porous architecture, producing a positive model of the product, infiltrating the model with a salt-containing paste, drying the paste, removing the material comprising the positive model leaving a negative salt template, infiltrating the salt template with molten Mg or Al or alloy, allowing the Mg or Al or alloy to solidify, and removing the salt template to leave the Mg or Al or alloy product with the controlled porous architecture. In some embodiments the method includes controlling the Mg or Al infiltration pressure to control the extent to which a texture or pattern of the internal surfaces of the model is imprinted on the internal surfaces of the end product.

### FIELD OF THE INVENTION

The invention relates to a method of preparing magnesium (Mg) or aluminium (Al) or Mg or Al alloy components having ordered porosity or controlled porous architecture.

### BACKGROUND TO THE INVENTION

Magnesium (Mg) is the lightest engineering metal used industrially. Mg is lighter than aluminium and Mg and Mg alloys are used in many engineering, industrial and transport applications where lightweight properties are important.

Mg and its alloys have been proposed as biomaterials for medical applications such as in orthopaedic implants. Mg is found to have properties of biocompatibility and is biodegradable in vivo. For some applications, the implant is required to have an open or interconnected porous architecture to act as a scaffold or support structure that will support the growth of new tissue and/or cells through the implant and in desired directions. In this case, interconnected porosity is important to allow the passage of bodily fluids through the implant to support cell proliferation and new tissue growth. Interconnected porosity also allows the administering of drugs to the interior of the implant and/or area surrounding the implant site.

It is known to produce Mg or Al foams using a random negative template structure of sodium chloride (NaCl). Such foams have interconnected porosity. NaCl particles are placed in a mould to fabricate a NaCl template, heated to 200° C. to dry the NaCl, and then infiltrated with liquid Mg or Al, and subsequently after the Mg has solidified the NaCl is removed by dissolution in an aqueous solution such as sodium hydroxide, leaving the porous Mg or Al product. This produces a random porous structure as shown in FIGS. 1a and 1b respectively for Mg and Al samples. Such interconnected or open porosity is important for many applications such as for example in biomedical implants as referred to above.

The above discussion is not to be taken as an admission that this subject matter or any of it is part of any common general knowledge in the field relevant to the invention as the priority date.

### SUMMARY OF THE INVENTION

The invention provides an improved or at least alternative method specifically for preparing a porous Mg or Al or alloy product, in which the product has a controlled porous architecture rather than random porosity.

In broad terms in one aspect the invention comprises a method of forming a porous Mg or Al or Mg or Al alloy (herein collectively: Mg or Al) product, comprising the steps of:
computationally designing the product including a controlled porous architecture of interconnected porosity within the product,
producing a three dimensional positive model of the product including said controlled porous architecture using rapid prototyping,
infiltrating the model with a salt-containing paste and drying the paste,
removing the material comprising the model, leaving a negative salt template,
infiltrating the salt template with molten Mg or Al by application of pressure and then allowing the Mg or Al to solidify, and
removing the salt template, to leave the Mg or Al product with said controlled porous architecture.

By “rapid prototyping” is meant causing a machine to produce the three dimensional (3-D) model in a series of machine steps and under control of a computer and based on a computer representation of the product design including the designed controlled porous architecture produced by said computational designing of the product. For example the external shape of the product and its internal controlled porous architecture may be designed using computer aided design (CAD), and then either stereolithography or 3-D printing used to machine-build up the positive model in a layer-by-layer process, from a UV-curable resin, or a combination of printed build and support materials, respectively. Methods of rapid prototyping (RP) other than stereolithography or 3-D printing may alternatively be used for the purpose of building the positive model such as other solid freeform fabrication processes for example.

The model, template, and Mg or Al end product have a controlled porous architecture meaning that the porosity in the product or at least a part (or parts) of it is as designed rather than random, and the porosity may also be ordered meaning that it is also regular or periodic at least in one direction if not in two, three or more directions through at least part of the model, template, and Mg or Al end product. The porosity is interconnected meaning that at least some or at least a major fraction or substantially all open pores intersect with at least some other open pores which extend in a different direction.

The method of the invention produces products having interconnected porosity having a controlled architecture and which may also be ordered. This in turn allows control of properties of the product, which may include mechanical properties e.g. strength or stiffness, or the volume ratio (fraction) i.e. the surface area to volume ratio, or surface properties e.g. surface area or corrosion rate, and density. The method of the invention also enables control of properties at different locations within the product, to produce for example a gradient of porosity and/or volume fraction through the product, or otherwise to optimise the product design for requirements of different applications.

The method may include sintering the salt template prior to infiltrating the salt template with Mg or Al. Salt particles are naturally angular in shape. In one embodiment prior to sintering of the salt template there is a pre-step of partial melting of the initial salt particles to at least reduce angular edges of the salt particles and optionally to form substantially spherical particles which then aid the subsequent sintering process.

In one embodiment the method may be used for producing biomedical implants such as orthopaedic implants including spinal fusion devices, rods, bone plates, bone screws, and parts of hip, knee or other joint prostheses into which bone growth is desired, for example, or tissue scaffolds, all with a controlled porous architecture which also has a predetermined orientation relative to the external implant shape to allow or cause bone or tissue growth through the implant in a desired direction.

In other embodiments the method may be used for producing other products with a controlled porous architecture for other applications, such as filtration devices or in electronic applications such as batteries, or similarly in other applications where control over the interior and exterior surface area of the product or device is important.

The invention also includes porous Mg or Al products with controlled porous architecture produced substantially according to the above method.

The terms “comprising” or “comprises” as used in this specification means “consisting at least in part of”, that is to say when interpreting independent paragraphs including that term, the features prefaced by that term in each paragraph will need to be present but other features can also be present.

### BRIEF DESCRIPTION OF THE FIGURES

The invention will now be described by way of example only and with reference to the drawings in which:

FIGS. 1a and 1b show samples with random interconnected porous structure, of Mg and Al respectively, FIG. 1 showing the whole sample which is cylindrical in shape and FIG. 2 showing a portion of a sample close up,

FIGS. 2a-c show repeat units of CAD structures useful in the design of products with controlled porous architecture, and FIGS. 2d-f show cylindrical products designed with the units of FIGS. 2a-c respectively,

FIG. 3 is a schematic diagram of the steps of the method of the invention,

FIG. 4 schematically illustrates production of a polymer model,

FIG. 5 shows an infiltration device for salt paste and a sandwich mould and a polymer model referred to in the subsequent description of experimental work,

FIG. 6 schematically shows the infiltration device in a pressure-application device, and the introduction of salt paste into the model by increasing pneumatic air pressure,

FIG. 7 shows a polymer model impregnated with salt and after drying of the NaCl, before burn-out of the polymer model to leave the NaCl template,

FIG. 8 is a heat treatment temperature-time profile for the burn-out of the model from the salt template and subsequent sintering times referred to in the subsequent description of experimental work,

FIG. 9 shows a salt template after burning out of the polymer model,

FIG. 10 shows the casting apparatus used to infiltrate the Mg into the salt template referred to in the subsequent description of experimental work,

FIG. 11 is a flow chart of temperature pressure steps and times used to infiltrate the Mg into the salt template referred to in the subsequent description of experimental work,

FIG. 12 is an enlarged view of a section of a final Mg product illustrating the structured porosity thereof,

FIG. 13 shows a bone screw formed by the method of invention and FIG. 13a shows the porosity of a portion of the bone screw, and

FIG. 14 shows a plan view of a spinal fusion device formed by the method of the invention and FIGS. 14a-d show the different porosities in different parts of the spinal fusion device.

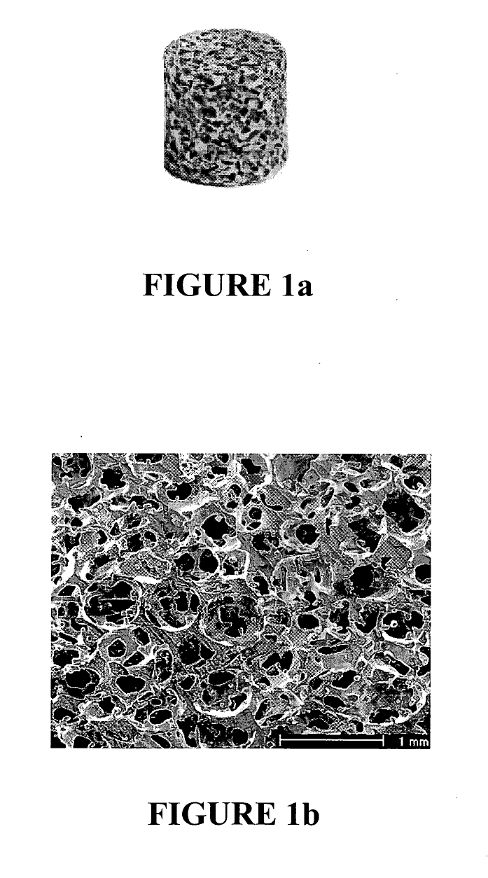

### DETAILED DESCRIPTION OF EMBODIMENTS

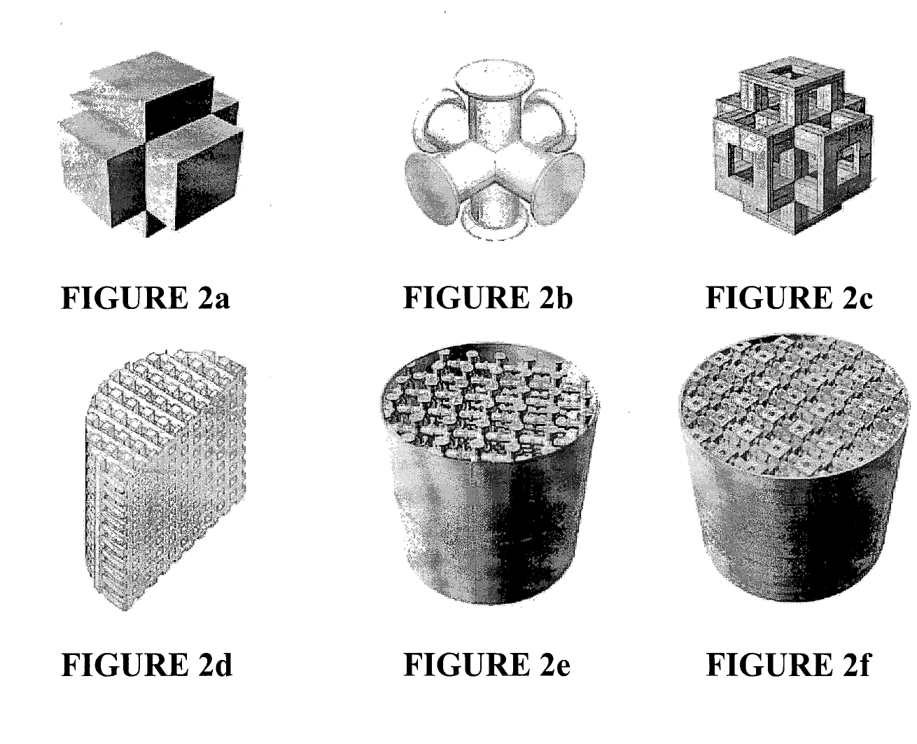

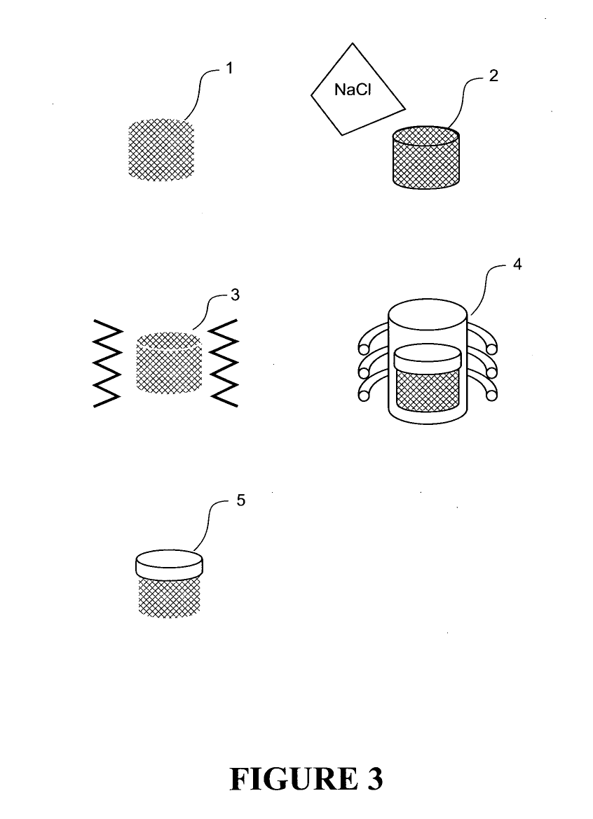

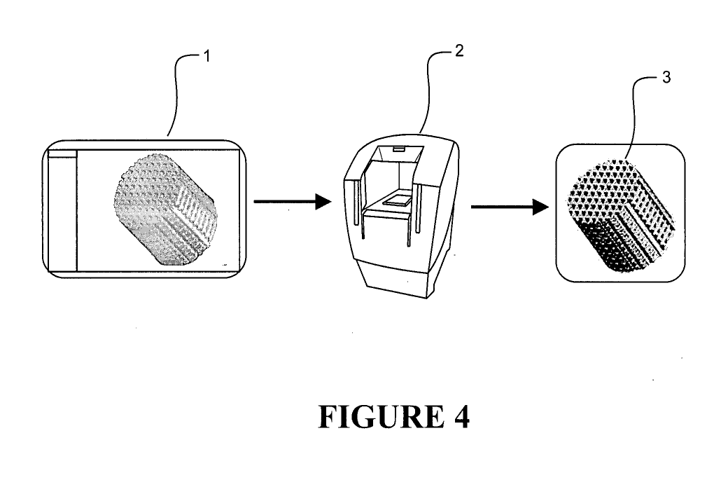

Referring first to FIGS. 3 and 4, in accordance with the method of the invention first a product with a controlled porous architecture is computationally designed using CAD software on an appropriate hardware platform, as indicated at 1 in FIG. 4. The product may be a whole product or a part or component of a larger product, for any industrial, commercial, domestic, medical or similar application, required to be formed of Mg or Al or an Mg or Al alloy and required to a controlled porous architecture through the product or at least a portion of the product. The external shape of the product is designed and the internal controlled porous architecture within the product is designed. The porosity may also be ordered. The interconnected porosity extends to the external surface of the product at all or substantially all of the external surface area of the product, or alternatively preferably at least a major part of the external surface area of the product. The internal controlled porous architecture may have a constant porosity through the product or a varying porosity. For example the porosity may be designed to vary so that there is a porosity gradient through the product in at least one direction or axis of the product and optionally in two or more directions or axes of the product. One advantage of providing such a porosity gradient through the product or a part of the product where the product is a bio-implant is that the product may degrade in situ in the body at a different rate along the gradient. Where there is lower porosity and greater thickness and/or volume of metal material the product will take longer to degrade away completely than in a part of the product in which there is relatively higher porosity and lower metal material. The controlled porous architecture of the product may be designed to achieve a desired degradation gradient across the product in any one or more axes, or differing rates of degradation of the product in situ in different parts of the product. The porosity may vary from a maximum porosity at or near an external surface of the product to a lesser porosity within a part of the interior of the product or at or near another part of the external surface of the product, or vice versa. The model, template, and Mg or Al end product have a controlled porous architecture meaning that the porosity in the product or at least a part (or parts) of it is as designed rather than random, and the porosity may also be ordered meaning that it is also regular or periodic at least in one direction if not in two, three or more directions through at least part of the model, template, and Mg or Al end product. The porosity is interconnected meaning that at least some or at least a major fraction or substantially all open pores intersect with at least some other open pores which extend in a different direction. The product may be designed to have predetermined mechanical properties e.g. strength or stiffness, which may also vary across the product in one or more axes or simply in different parts of the product. The product may be designed to have a predetermined volume ratio, or a predetermined density. The product may be designed to have predetermined surface properties e.g. surface area or surface topography. The method of the invention also enables control of properties at different locations within the product, to produce for example a gradient of porosity through the product, or otherwise to optimise the product design for requirements of different applications. Repeat units of some different CAD structures are shown in FIGS. 2a-2c as examples of unit cells which may be used in the design of the product porosity to achieve ordered porosity or a controlled porous architecture of different porosities and dimensions. Porosities, example dimensions and volume fraction for these unit cells are given in Table 1 below. Combinations of these and/or other design unit cells may be used to create varying porosities pore architectures or volume fractions or porosity, pore architecture or volume fraction gradients through the product. Using a common interface for connecting design unit cells together facilitates building porosity architectures with different unit cells.

TABLE 1

| | FIG. 2a - | FIG. 2b - | FIG. 2c - |
|---|---|---|---|
| Unit cell architecture | Square - bar | Fire hydrant | Crossbeam |
| Porosity (%) | 50 | 80.3 | 60.8 |
| Strut sizes (mm) | 1.0 × 1.0 | 0.9 | 0.6 × 0.6 |
| Interface size (mm) | N/A | Ø1.3 | 1.6 × 1.6 |
| Interface thickness (mm) | N/A | 0.15 | 0.15 |
| Volume fraction | 2.25 | 1.18 | 2.75 |
| (mm²/mm³) | | | |

Rapid prototyping (RP) is then used as indicated at 2 in FIG. 4, to produce a full size positive model of the product in a series of machine steps and under control of a computer and based on a computer representation of the product design from the prior CAD process, as indicated at 3 in FIGS. 3 and 4. For example, stereolithography or 3-D printing is used to build up the model in a layer-by-layer process from a UV-curable resin or a combination of printed build and support materials, respectively.

A paste consisting of suspended and/or partially dissolved salt and a background fluid is prepared and the positive RP model is infiltrated with the paste as indicated at 4 in FIG. 3 under pressure to force the paste into the porous interior of the positive model. The salt must have a melting or decomposition temperature at least higher than that of the melting point of Mg and Al which are 650° C. and 661° C., respectively. A preferred material for producing a template is sodium chloride (NaCl) as it has a melting point of 801° C. NaCl is also highly soluble in various liquid solvents such as water so that it is easily subsequently flushed from the solidified end product. Furthermore, in biomedical implant applications small amounts of residual salt in the structure do not have any significant detrimental effect in vivo as these elements occur naturally in human blood serum. Other examples of a suitable salt or salt mixture may include calcium chloride and potassium chloride. Gelatin and/or one or more other compatible polymers are preferably added to NaCl and water to create a paste. Gelatin is a large molecular weight water soluble protein formed from hydrolysis of animal collagen and is also biocompatible. Gelatin and/or one or more other compatible, water soluble polymers may act as a lubricant and/or plasticiser for the NaCl-water paste at ambient temperatures to facilitate subsequent impregnation of the salt into the positive RP model. An example of a paste formulation suitable for infiltration of the RP model comprises three main components: (i) suspension of solid NaCl particles, (ii) dissolved NaCl in the form of Na+ cations and Cl− anions giving a supersaturated solution in water, and (iii) gelatin (80-300 Bloom). Other high molecular weight polymers (or proteins), including cross linkable polymers, that are soluble in water and interact with supersaturated NaCl solutions may also suitable lubricants and/or plasticisers e.g. cellulose and its derivatives. Common gelling agents such as starch, alginate, pectin, agar, carrageenan, etc. are also useful for the purpose in which gelatin is used here.

By paste is meant a substance that behaves as a solid until a sufficiently large load or stress is applied, at which point it flows like a fluid (also known in rheological terms as a Bingham plastic or fluid). A paste typically consists of a suspension of granular material in a background fluid. Interactions between the suspended material and fluid leads to bonding that gives rise to a critical stress required for the paste to flow. By Bloom is meant the standard measure of the gel strength of a gelatin, also reflecting the average molecular weight of its constituents. The higher the Bloom number the stiffer the gelatin and the higher the molecular weight of the gelatin.

Next the salt paste is dried and then the material comprising the positive RP model is removed, typically by burning out of the material at elevated temperatures as indicated at 5 in FIG. 3, thus forming a negative salt template with the controlled porous architecture.

Preferably the salt template is heated to sinter it before infiltration with liquid Al or Mg to improve bonding between the salt particles. Sintering by solid state diffusion is preferred to alternatively fusing the salt particles with water or solvent. Sintered salt templates have greater strength than those fused by water or solvents which means that higher pressures can be applied during molten metal infiltration, which is especially useful in preparing porous components of larger dimensions where higher pressures need to be exerted on the salt template to ensure complete infiltration.

Spherical shaped salt particles can also be formed using a pre-treatment that involves partial melting of the initially angular salt particles. One example of this spheroidization process involves partial remelting of salt particles by feeding the angular salt particles into the flame of a high temperature gas source such as oxyacetylene using temperatures at least as high as 800° C. at the surface of the particles in the case of NaCl. Temperatures in the range of 800-4000° C. can be used for remelting of NaCl. Rapid cooling of the remelted surface of the particles results in the development of residual stresses on the surface of particles which then accelerates the sintering process due to an increase in the surface energy of the particles. A salt template based on spherical particles may be stronger than that based on angular particles, leading to a template that can better withstand the forces of liquid metal infiltration. Spherical particles also offer an alternative surface topology that is useful for different applications. The surface topology of the internal surfaces of the salt template may be transferred by replication to the internal surfaces of the final porous Mg or Al product.

The salt template is then infiltrated with molten Mg or Al typically under pressure, as indicated at 6 in FIG. 3, to force the liquid metal into the porous interior of the salt template, and preferably under an inert atmosphere such as high purity argon to avoid oxidation of the Mg or Al melt, and finally the Mg or Al is allowed to solidify.

In one embodiment where the method is used for forming biomedical implants the metal is forced into the porous interior of the salt template under sufficient pressure that the liquid metal intimately wets or contacts the interior surfaces the salt template throughout its interior. This results in an imprint of the individual salt particles onto the internal surfaces of the final porous metal. By controlling the infiltration pressure the extent to which the surface topology e.g. roughness and texture of the template is imprinted on the internal surfaces of the implant can be controlled or varied. Roughness and/or alignment of surface topological features may encourage cell proliferation and new tissue growth in such implants. For example impregnation of metal at a pressure below about 1.5 Bar may achieve a product in which the interior surfaces of the product are relatively smooth while infiltration within increasing pressures above about 1.5 Bar may lead to increasing intimate contact of the liquid metal with the internal surfaces of the salt template and in turn increasing roughness of the internal surfaces of the end product. Infiltration at a pressure of about 1.8 Bar or above may be desirable for biomedical implants.

Alternatively or additionally to the above a predetermined surface topology or pattern may be designed into the RP model to in turn provide a predetermined surface topology to be replicated in the salt template and then the interior surfaces of the end product, such as for example a predetermined surface patterning or texturing, which may in one form include surface grooving or lines, which may have a predetermined alignment relative the porosity architecture. In some RP processes such as 3-D printing the layer-by-layer fabrication process results in aligned grooves, on the surface of the positive model, which may be referred to as micro-valleys, and will be advantageously replicated to varying extents on the interior surfaces of the Mg or Al or end product. This is useful for the controlled directional growth of various tissues in the human body.

The negative salt template is subsequently removed by dissolving out with a suitable solvent such as water for NaCl for example, or any other suitable solvent for the particular salt used which will not adversely affect the Mg or Al, leaving the end product with structured porosity or controlled porous architecture, as indicated at 7 in FIG. 3. Another example of an appropriate solvent is an ionic liquid which will not corrode the Mg or Al structure e.g. 1-butyl-3-methylimidazolium acetate. For example the Mg—NaCl model may be immersed in the ionic liquid and heated to 90-110° C. for about 10 mins to thoroughly remove all NaCl without corroding the Mg. The ionic liquid is then washed away completely with a solvent such as ethanol using an ultrasonic cleaner for about ˜8 mins.

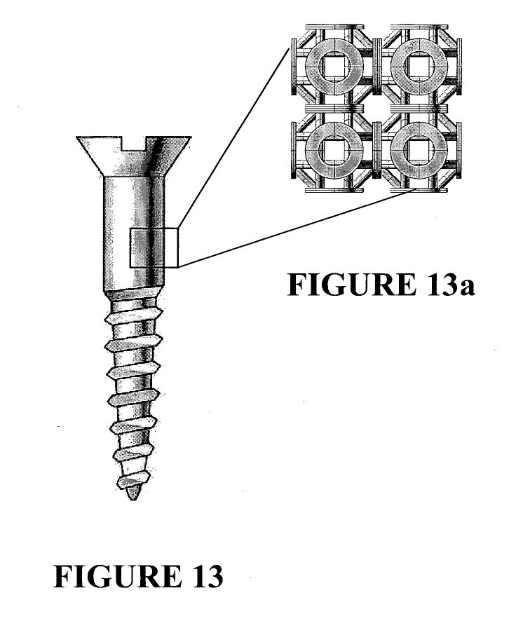

FIG. 13 shows a bone screw formed by the method of invention and FIG. 13a shows the porosity of a portion of the bone screw. All of the body of the screw may comprise a controlled porous architecture or optionally only one or more parts of the screw such as the non-threaded upper part of the shaft of the screw and/or threaded lower part of the shaft of the screw may comprise the controlled porous architecture, but not the head of the screw, for example.

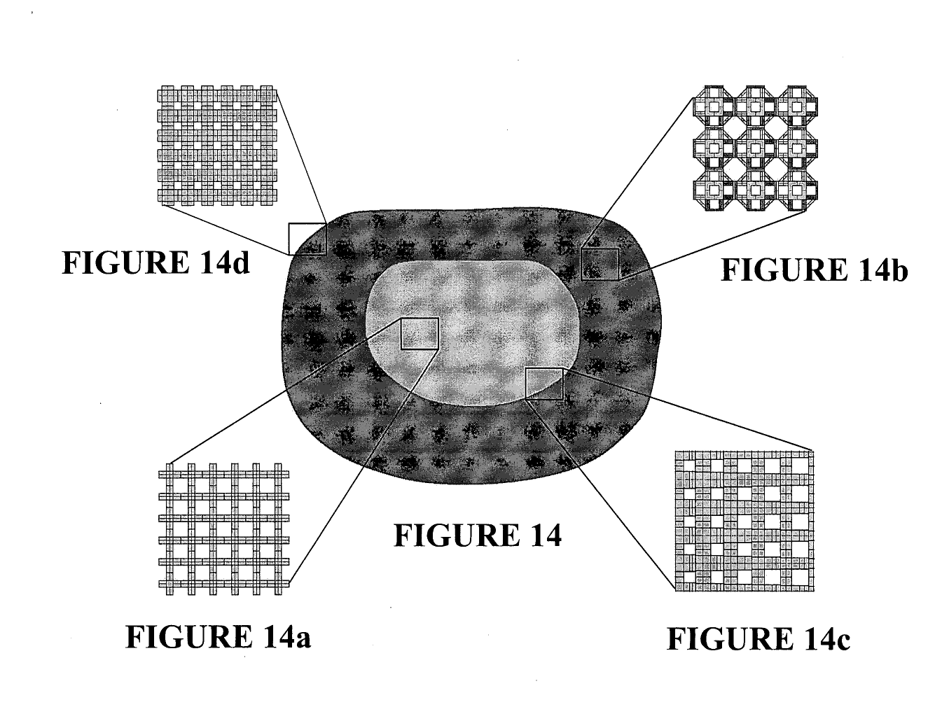

FIG. 14 is a plan view of a spinal fusion device formed by the method of the invention and FIGS. 14a-d show different porosities in different parts of the spinal fusion device. In a centre part of the spinal fusion device the device has relatively low porosity with an architecture in this part as shown in FIG. 14a, and at an outer surrounding part the device has relatively higher porosity with an architecture as shown in FIG. 14b. In an intermediate transitional part of the spinal fusion device the porosity has an middle porosity architecture as shown in FIG. 14c, relative to FIGS. 14a and b, so that there is a gradient of increasing porosity from the centre to the outer part of the spinal fusion device (FIG. 14a-14c). In a outer most peripheral part of the device the device has relatively low porosity, but high strength, as with an architecture as shown in FIG. 14d.

### Example

The following description of experimental work further illustrates the invention by way of example.

### Production of the Positive RP Model

Three magnesium products as shown in FIGS. 2d-f were designed in 3-D CAD software as indicated at 1 in FIG. 4. In each case the file was then transferred to a rapid prototyping modeller at 2 in the STL file format, which built a polymer replica 3 of the magnesium part. The InVision VisiJet® HR200 system from 3D Systems was used and the polymer found to have good burn-out properties, no leftover residue, and adequate strength and stiffness properties resulting in subsequent minimal deformation of the polymer model when infiltrated with salt paste under pressure. The InVision VisiJet® HR200 system uses a wax support (M100) while building the part, which is melted out afterwards. If any wax residue persists this is removed by heating the positive RP model in the range of 50-70° C. using either an oven or ultrasonic bath.

Three different ordered structures were chosen for manufacturing:
A simple square bar structure as shown in FIGS. 2a and 2d with three orthogonal 1×1 mm square struts and channels, having a porosity of 50%.
A fire hydrant design as shown in FIGS. 2b and 2e with slightly more complex with cylindrical beams. The fire hydrant design also incorporates a cylindrical disc that acts as a common interface for connecting the repeat units together. The disc was 0.15 mm in thickness and 1.3 mm in diameter. Each beam is 2.7 mm in length and 0.9 mm in diameter, resulting in a structure that is 90% porous.
A crossbeam design as shown in FIGS. 2c and 2f, with twelve rectangular 0.6×0.6 mm struts intersecting each other.

Common interfaces consisted of a hollow rectangular block. The crossbeam structure had a porosity of 60.8%. Repeated subunits for the fire hydrant and crossbeam designs were linked together to generate 3D cylindrical models 20 mm in height and 20 mm in diameter. Rapid prototyped (RP) polymer template structures of all three designs were then fabricated on a commercial 3D-printer.

### Salt Paste Preparation

An aqueous NaCl paste was prepared. The NaCl was ground and sieved for particles in the range of 45-63 μm. All handling of the NaCl was performed at a humidity lower than 75% to prevent NaCl absorbing moisture from the air, The paste also contained 7.9 wt. % LabChem gelatin powder (supplied by Ajax Finechem, gelatin 1080-500G, 141 Bloom) and 19.3 wt. % supersaturated NaCl solution in water. All equipment and substances were kept in a temperature-controlled room at 20° C. to avoid changes in the properties of the gelatin due to varying temperature. All of the paste ingredients were then mixed using a Heidolph overhead stirrer (Model RZR 2-64) at a speed of 50-60 RPM for 25-30 min, depending on the amount of material.

### Salt Paste Infiltration

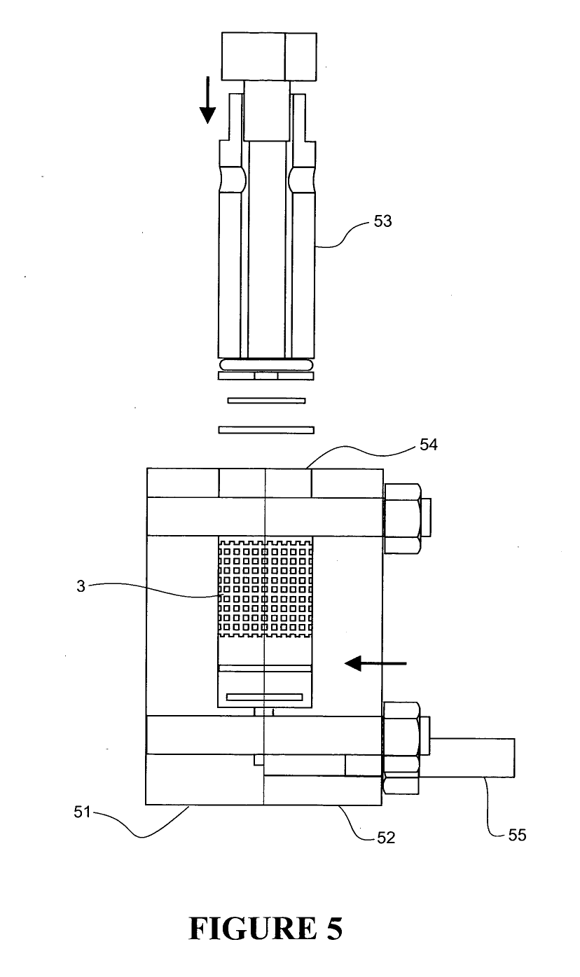

In each case the NaCl paste was forced into the positive RP model using an infiltration device as shown in FIG. 5. The device comprised two body halves 51 and 52 bolted together and defining between them an internal cavity in which was housed the polymer model as indicated at 3. Salt paste was infiltrated into the model 3 within the housing from the top using a plunger operating in a cylinder as indicated at 53 fitted into an aperture 54 in the housing.

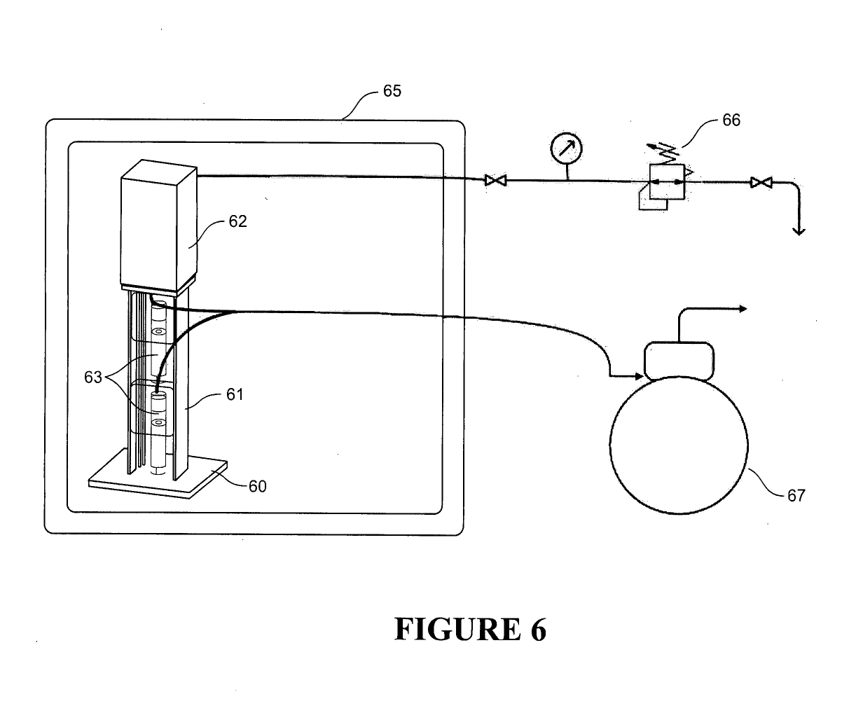

The infiltration device was then placed in a press as shown schematically in FIG. 6, comprising a base 60, frame 61, and pneumatic ram 62. Two infiltration devices indicated each at 63 in FIG. 6 and each as shown in FIG. 5 were stacked in the frame 61 of the press between the base 60 and ram 62. The thus loaded press was then placed in a furnace 65, while remaining connected to a source of pneumatic pressure to the ram 62 controllable via a variable regulator 66, and a vacuum pump 67 was connected to a port 55 (see FIG. 5) to the interior of each infiltration device and then the paste slowly squeezed into the RP model by increasing pneumatic air pressure. The paste was kept under pressure for 1 hr in the furnace at 50° C., allowing the paste to warm up so as to lower the viscosity of the paste. Once the gelatin was sufficiently heated, the valve in the cylinder was opened, pressure dropped to 0.5 MPa and a vacuum was then applied to ports 55. The vacuum removed most of the gelatin from the NaCl via a lower filter while a top filter allowed air in. Millex-GP polypropylene filters were used having a pore size of 0.22 μm. The vacuum pump was run for ˜22 hrs to allow the structure to dry, resulting in the production of a high strength NaCl template.

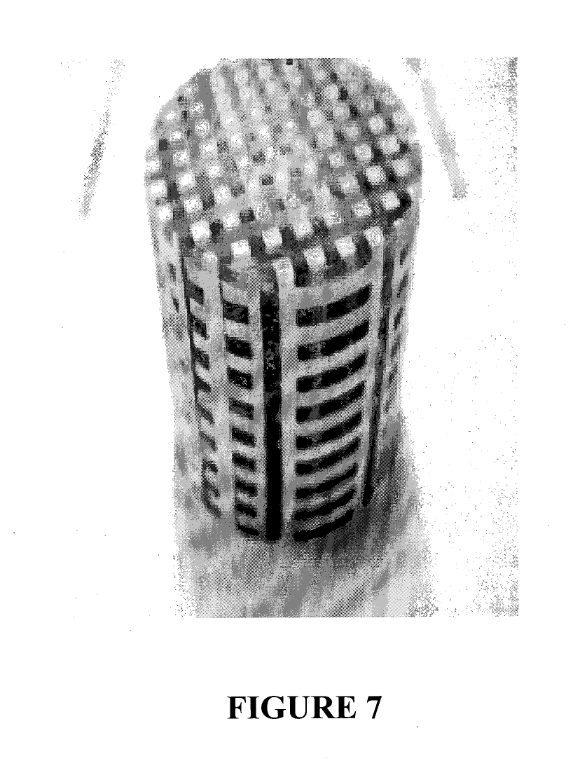

FIG. 7 shows a polymer model after infiltration by the salt paste and drying. The lighter parts are salt and the darker parts the polymer model.

### Burn-Out and Sintering Procedure

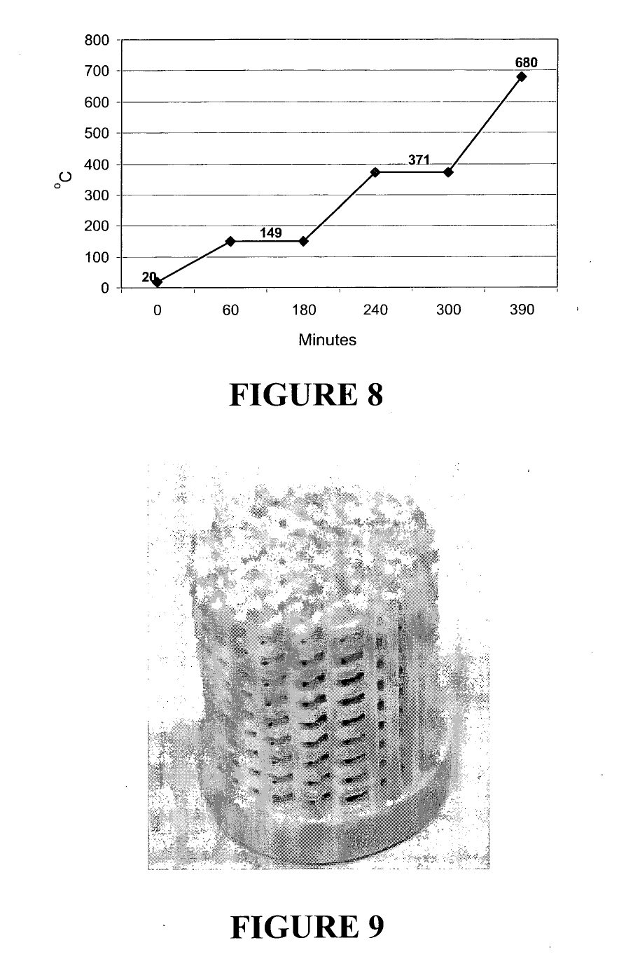

Following infiltration, the polymer was removed from the NaCl-polymer model using a burn-out procedure. A tube furnace was used for the burn-out cycle as it allowed good control of the airflow needed to remove the carbon residue left after burning out the polymer. The burn-out procedure took a total of 6.5 hrs, with 5 hrs for heating up and burn-out and 1.5 hrs for subsequent sintering of the NaCl template. FIG. 8 shows the combined temperature-time profile of the burn-out and sintering stages. Sintering temperatures can be varied in the range of 650-800° C. and sintering times in the range of 1-48 hrs. FIG. 9 shows a salt template after burning out of the polymer model.

### Casting

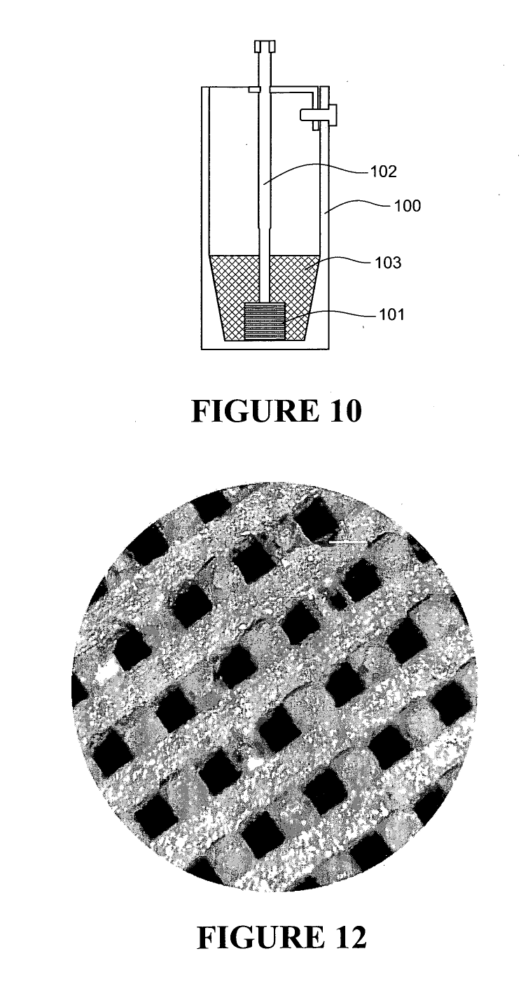

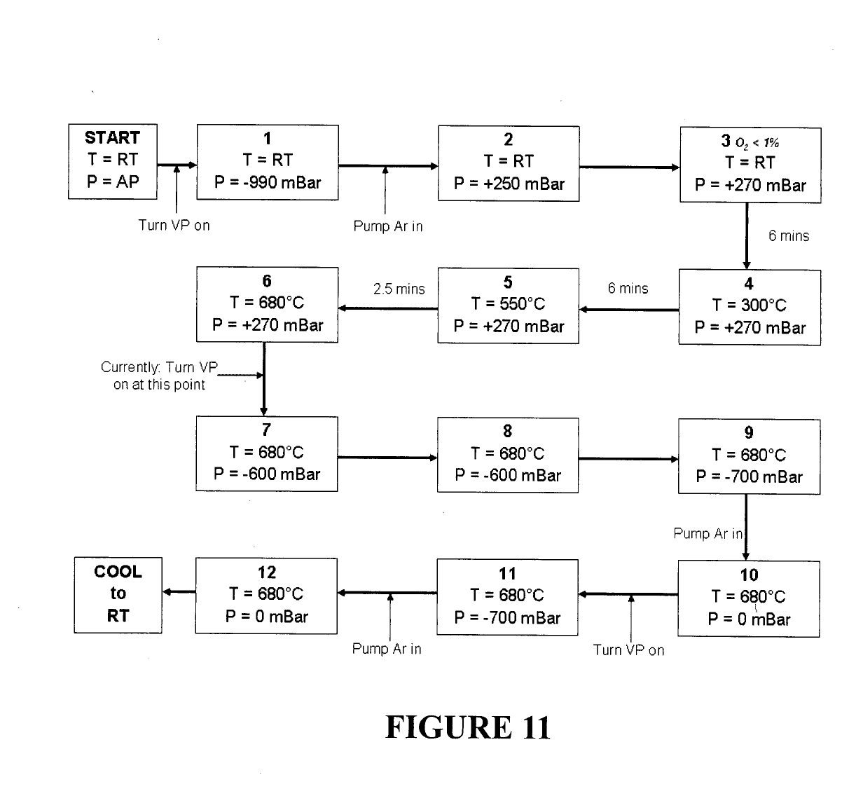

A low pressure casting method was used to cast molten or liquid magnesium (Mg) into the NaCl template. FIG. 10 shows the casting apparatus used. It comprised a chamber 100 into which the salt template 101 carried by a rod 102 was placed. The bottom of the chamber was then filled with magnesium pieces 103 to above the height of the template 101 and the chamber 100 placed in a furnace. Pneumatic pressure was applied to the interior of the chamber to force the molten metal into the template 101. Pressures in the range of −550 to −690 mBar were applied while the Mg was melting. Once the Mg was completely molten, the pressure inside the chamber was then reduced further to approximately −700 mBar. The above sequence of applied pressures helps to aid complete infiltration and avoidance of voids or air pockets in the final solidified Mg or Al structure. Subsequently, the chamber was re-pressurised with argon (or another inert gas could be used) to create a pressure differential that forced the liquid Mg to flow into and permeate the negative NaCl template. The Mg was then allowed to cool to room temperature to completely solidify. The sequence of temperature and pressure steps and times used is shown as a flow diagram in FIG. 11 in which T=temperature, RT=room temperature, P=pressure, and AP=atmospheric pressure.

After the Mg had solidified, the NaCl was removed by dissolution using a sodium hydroxide (NaOH) solution with a pH greater than 11, leaving a Mg structure with an ordered or controlled porous architecture. FIG. 12 is an enlarged view (relative to FIGS. 5 and 7) of a section of a final Mg product so formed.

Although the invention has been described by way of example and with reference to particular embodiments, it is to be understood that modifications and/or improvements may be made without departing from the scope or spirit of the invention as defined in the accompanying claims.

1. A method of forming a product of Mg or Al or an alloy thereof, having interconnected porosity, comprising the steps of:
computationally designing the product including a controlled porous architecture of interconnected porosity within the product,
producing a positive model of the product including said controlled porous architecture using rapid prototyping,
infiltrating the positive model with a salt-containing paste and drying the paste,
removing the material comprising the positive model, leaving a negative salt template,
infiltrating the salt template with molten Mg or Al or alloy and then allowing the Mg or Al or alloy to solidify, and
removing the salt template to leave the Mg or Al or alloy product with said structured porosity or controlled porous architecture.

2. A method according to claim 1 including computationally designing the product so that the controlled porous architecture of the model is also ordered in at least in one direction through at least part of the model.

3. A method according to claim 1 including computationally designing the product so that the controlled porous architecture of the model is ordered in at least two directions through at least part of the model.

4. A method according to claim 1 including computationally designing the product so that the controlled porous architecture of the model is ordered in three directions through at least part of the model.

5. A method according to claim 1 including computationally designing the external shape of the product and the internal controlled porous architecture in a predetermined orientation relative to the external shape of the product.

6. A method according to claim 1 including computationally designing the product to comprise a constant porosity through the product.

7. A method according to claim 1 including computationally designing the product to comprise a varying porosity through the product.

8. A method according to claim 1 including computationally designing the product so that the porosity of the product varies in at least in one direction through at least part of the model.

9. A method according to claim 1 including computationally designing the product so that porosity of the product varies in at least two directions through at least part of the model.

10. A method according to claim 1 including computationally designing the product so that the porosity of the product varies in three directions through at least part of the model.

11. (canceled)

12. A method according to claim 1 including computationally designing the product to comprise a predetermined surface topography on at least part of the internal surfaces of the model.

13. A method according to claim 1 including producing the positive model of the product by causing a machine to produce the model in a series of machine steps and under control of a computer and based on a computer representation of the product design to build up the model in a layer-by-layer process.

14. A method according to claim 13 including producing the positive model of the product using rapid prototyping including stereolithography.

15. A method according to claim 14 including building up the positive model in a layer-by-layer process from a UV-curable resin.

16. A method according to claim 13 including producing the positive model of the product using rapid prototyping including 3-D printing.

17. A method according to claim 1 including controlling the pressure of said infiltrating of the positive model with a salt-containing paste to control the extent to which a surface topography of the internal surfaces of the model is imprinted on the internal surfaces of the product.

18.-23. (canceled)

24. A method according to according to claim 1 wherein the product is a biomedical implant.

25. A method according to claim 1 wherein the product is an orthopaedic implant.

26. A method according to claim 1 wherein the product is a tissue scaffold for supporting tissue formation and repair.

27. A method according to claim 25 including computationally designing the product to comprise porosity variations through the orthopaedic implant such that different parts of the orthopaedic implant will degrade in situ in the body at different rates.

28.-29. (canceled)

30. A method of forming a medical implant interconnected porosity, comprising the steps of:
computationally designing the implant including the external shape of the implant and a controlled porous architecture in a predetermined orientation relative to the external shape of the implant,
producing a positive model of the implant including said controlled porous architecture by causing a machine to produce the model in a series of machine steps and under control of a computer and based on a computer representation of the implant design to build up the model,
infiltrating the positive model with a salt-containing paste and drying the paste,
removing the material comprising the positive model, leaving a negative salt template,
infiltrating the salt template with molten Mg or Al or alloy and then allowing the Mg or Al or alloy to solidify, and
removing the salt template to leave the Mg or Al or alloy implant with said structured porosity or controlled porous architecture.

31. A method of forming a medical implant interconnected porosity, comprising the steps of:
computationally designing the implant including the external shape of the implant and a controlled porous architecture in a predetermined orientation relative to the external shape of the implant,
producing a positive model of the implant including said controlled porous architecture by causing a machine to produce the model in a series of machine steps and under control of a computer and based on a computer representation of the implant design to build up the model in a layer-by-layer process,
infiltrating the positive model with a salt-containing paste and drying the paste and controlling the pressure of said infiltrating to control the extent to which a texture or pattern of the internal surfaces of the model is imprinted on the internal surfaces of the implant,
removing the material comprising the positive model, leaving a negative salt template,
infiltrating the salt template with molten Mg or Al or alloy and then allowing the Mg or Al or alloy to solidify, and
removing the salt template to leave the Mg or Al or alloy implant with said structured porosity or controlled porous architecture.

32.-34. (canceled)

35. A method according to claim 26 including computationally designing the product to comprise porosity variations through the tissue scaffold such that different parts of the tissue scaffold will degrade in situ in the body at different rates.
